(19) United States
(12) Patent Application Publication
(10) Pub. No.: US 2011/0278947 A1
(43) Pub. Date: Nov. 17, 2011

(54) ANTENNA DEVICE, TRANSPONDER READER, INDUCTION COOKER

(75) Inventors: Andreas Hennig, Muehlheim (DE); Gerd Vom Boegel, Wuelfrath (DE)

(73) Assignee: Fraunhofer-Gesellschaft zur Foerderung der angewandten Forschung e.V., Munich (DE)

(21) Appl. No.: 13/107,033

(22) Filed: May 13, 2011

(30) Foreign Application Priority Data
May 14, 2010 (DE) 10 2010 028 992.2

(51) Int. Cl. H01F 38/14; H05B 6/36; H01F 38/00

(52) U.S. Cl. 307/104; 336/105; 219/672

(57) ABSTRACT

An antenna device has an inductive transmitting antenna having a main radiation direction, a plurality of spaced apart, adjacent conductors and a reference potential terminal. The plurality of spaced apart, adjacent conductors is connected to the reference potential terminal and arranged in a predetermined distance from the transmitting antenna along the main radiation direction in a plane antiparallel to the main radiation direction.

### CROSS-REFERENCE TO RELATED APPLICATIONS

This application claims priority from German Patent Application No. DE 10 2010 028 992.2, which was filed on May 14, 2010, and is incorporated herein in its entirety by reference.

### BACKGROUND OF THE INVENTION

Embodiments of the present invention describe an antenna device like it may, for example, be found in a transponder reader, for example for RFID (radio identification) or NFC (near field communication) transponders or in hot plates for induction cookers. Further embodiments of the present invention describe a transponder reader and an induction cooker.

Transponder systems are used more and more in medicine and technology. A typical transponder system here consists of a reader (a so-called transponder reader or reader) and a transponder, which may be read by the transponder reader. The transponders here are typically purely passive, i.e. they receive their supply voltage from a magnetic or electric field generated by the transponder reader. In the following, the focus is on inductive systems, i.e. the transponders receive their supply voltage through a magnetic field generated by the transponder reader. When used in medicine and technology, the antennae of the readers are frequently in the direct vicinity of lossy materials like, e.g., body tissue or building material. For example, with implantable sensor transponders (transponders having a sensor) for blood pressure monitoring, the antenna of the reader for reading out the transponder is in direct contact (or in a very small distance to) with the human body. The unavoidably existing parasitic electric fields of the antenna (in particular at feeding points of the antenna) lead to currents in the human body or at other lossy media into which the transponder is inserted. The introduced energy is converted into heat and does not contribute to the supply of the transponder. Apart from that, from a medical viewpoint, an unnecessary heating up of body tissue is to be prevented.

FIGS. 6a-c show graphics of a simulation for illustrating the problem. FIG. 6a shows a conductor loop 110 generating a magnetic alternating field as an inductive antenna. In a plane 30 perpendicular to the conductor loop 110 the amount of the electrical field strength is represented in a hatched form. A dense hatching here refers to a high and a thin hatching to a low value of the electrical field strength. A high field strength at the feed or input 140 of the antenna 110 is clearly illustrated. In FIG. 6b now a lossy medium is brought in front of the antenna 110, like e.g. human tissue. In this simulation, this was realized in a simplified form by a cuboid. The cuboid 111 here has the dielectric parameters of human tissue. FIG. 6c now shows the amount of current density, represented in a hatched form. A high hatching is illustrated in the area of the cuboid 110. The electric field thus causes currents in the human tissue, which finally lead to heating up. This power loss has to be compensated by the signal source (the antenna 110 of the transponder reader).

The propagation of electric fields may be prevented by a shielding. Here, a highly conductive material (like e.g. copper) is used. However, the magnetic field is not to be influenced negatively. A conductive area as a shield may thus not be used. In such an area, eddy currents induced by the magnetic field weaken the magnetic field. For preventing parasitic electric fields, thus so-called sheath shields are known. An exemplary sheath shield is illustrated in FIG. 7. With these sheath shields the conductor loop 110 of the antenna (the reader) is enclosed by a sheath 10 of conductive material.

So that in the shield no induced currents may flow, the sheath 10 is interrupted (illustrated by a slot 20 between the two ends of the shield 10). The sheath shield thus has the form of an open conductor loop. The position of the position of interruption (the slot 20) is selected so that the same is located opposite to the feed 140 (the terminal) of the antenna. The voltage induced at the position of interruption 20 causes an electric field E (indicated by field lines 150′) which is, with respect to its orientation, opposed to the electric field E′ (designated by field lines 150) at the antenna feed 140. Thus, in a certain distance, a canceling results. The shielding effect is thus only present in a certain distance. This is a decisive disadvantage of the shield as in new applications no direct field may exist in the direct vicinity of the antenna.

### SUMMARY

According to an embodiment, an antenna device may have an inductive transmitting antenna having a main radiation direction; a plurality of spaced apart adjacent conductors; and a reference potential terminal connected to the plurality of conductors; wherein the plurality of the conductors is arranged in a predetermined distance from the inductive transmitting antenna along the main radiation direction in one plane; wherein an angle exists between the plane of the conductors and the main radiation direction; wherein the plurality of the conductors extend radially outwards originating from a first area within the plane, wherein the plurality of conductors in the first area are conductively connected to each other and to the reference potential terminal, and wherein each of the conductors branches into two adjacent partial conductors at a position spaced apart from the first area.

According to another embodiment, an antenna device may have an inductive transmitting antenna having a main radiation direction; a plurality of spaced apart adjacent conductors; and a reference potential terminal connected to the plurality of the conductors; wherein the plurality of the conductors is arranged in a predetermined distance from the inductive transmitting antenna along the main radiation direction in one plane; wherein an angle exists between the plane of the conductors and the main radiation direction; wherein the plurality of the conductors extend radially outwards originating from a first area within the plane, wherein the plurality of conductors in the first area are conductively connected to each other and to the reference potential terminal, and wherein a distance between two adjacent conductors of the plurality of the conductors is constant along extension directions of the two adjacent conductors.

According to another embodiment, a transponder reader may have an antenna device which may have an inductive transmitting antenna having a main radiation direction; a plurality of spaced apart adjacent conductors; and a reference potential terminal connected to the plurality of conductors; wherein the plurality of the conductors is arranged in a predetermined distance from the inductive transmitting antenna along the main radiation direction in one plane; wherein an angle exists between the plane of the conductors and the main radiation direction; wherein the plurality of the conductors extend radially outwards originating from a first area within the plane, wherein the plurality of conductors in the first area are conductively connected to each other and to the reference potential terminal, and wherein each of the conductors branches into two adjacent partial conductors at a position spaced apart from the first area.

According to another embodiment, a transponder reader may have an antenna device which may have an inductive transmitting antenna having a main radiation direction; a plurality of spaced apart adjacent conductors; and a reference potential terminal connected to the plurality of the conductors; wherein the plurality of the conductors is arranged in a predetermined distance from the inductive transmitting antenna along the main radiation direction in one plane; wherein an angle exists between the plane of the conductors and the main radiation direction; wherein the plurality of the conductors extend radially outwards originating from a first area within the plane, wherein the plurality of conductors in the first area are conductively connected to each other and to the reference potential terminal, and wherein a distance between two adjacent conductors of the plurality of the conductors is constant along extension directions of the two adjacent conductors.

According to another embodiment, an induction cooker may have an antenna device which may have an inductive transmitting antenna having a main radiation direction; a plurality of spaced apart adjacent conductors; and a reference potential terminal connected to the plurality of conductors; wherein the plurality of the conductors is arranged in a predetermined distance from the inductive transmitting antenna along the main radiation direction in one plane; wherein an angle exists between the plane of the conductors and the main radiation direction; wherein the plurality of the conductors extend radially outwards originating from a first area within the plane, wherein the plurality of conductors in the first area are conductively connected to each other and to the reference potential terminal, and wherein each of the conductors branches into two adjacent partial conductors at a position spaced apart from the first area.

According to another embodiment, an induction cooker may have an antenna device which may have an inductive transmitting antenna having a main radiation direction; a plurality of spaced apart adjacent conductors; and a reference potential terminal connected to the plurality of the conductors; wherein the plurality of the conductors is arranged in a predetermined distance from the inductive transmitting antenna along the main radiation direction in one plane; wherein an angle exists between the plane of the conductors and the main radiation direction; wherein the plurality of the conductors extend radially outwards originating from a first area within the plane, wherein the plurality of conductors in the first area are conductively connected to each other and to the reference potential terminal, and wherein a distance between two adjacent conductors of the plurality of the conductors is constant along extension directions of the two adjacent conductors.

Embodiments of the present invention provide an antenna device having an inductive transmitting antenna and a plurality of spaced apart and adjacent conductors. The inductive transmitting antenna comprises a main radiation direction. The plurality of spaced apart conductors are connected to a reference potential terminal of the antenna device. Further, the conductors are arranged in a certain distance from the transmitting antenna along the main radiation direction in a plane anti-parallel to the main radiation direction.

It is the basic idea of the present invention that an improved shielding of a parasitic electric field of an inductive antenna or an inductive antenna coil may be achieved when the electric field is shielded directly behind the antenna coil, but the magnetic field of the antenna coil is not negatively affected (or only negligibly). It was found that by arranging conductors in a predefined distance (which is for example as small as possible) from an inductive antenna coil a shielding of the parasitic electric field of the antenna coil is enabled and simultaneously by a suitable selection of a distance of the conductors with respect to each other a magnetic field of the inductive antenna coil is not negatively (or only negligibly) influenced. Distance and width of the conductors may here be selected so that no (or only a very small) eddy current may result in the conductors which would negatively influence the magnetic field or weaken the magnetic field. The conductors may be connected to each other and grounded in order to shield the electric field. An electric field strength of the parasitic electric field of the inductive antenna coil is thus significantly higher in an area between the inductive antenna coil and the conductor than behind the conductors. By a suitable selection of the spacings of the conductors to each other and the spacing of the conductor to the inductive antenna coil, the electric field strength of the parasitic electric field may be reduced by the conductors so that in a lossy medium, in which a transponder to be read is located, no substantial loss results by heating due to the electric field.

It is thus an advantage of the present invention that by shielding a parasitic electric field of an inductive transmitting antenna losses may be reduced which are generated by the electric field in lossy media. With transponder readers this may lead to an increased range of the transponder readers and/or to a reduced power consumption with the same range as compared to transponder readers in which no suppression of a parasitic electric field is implemented. Further, embodiments of the present invention enable a lower current consumption with induction cookers or with hot plates of induction cookers in which a heating of a pot or a pan is generated by a magnetic field of the transmitting antenna.

In the present application anti-parallel is in the meaning of non-parallel. Therefore, an angle exists between a plane and a direction, when the plane is anti-parallel to the direction. Hence, when the plane is antiparallel to the direction, a normal vector of the plane is not orthogonal to the direction (e.g. an angle between the normal vector of the plane and the direction is different from 90 degrees). Therefore, in embodiments, a normal vector of the plane of the conductors is not orthogonal to the main radiation direction of the transmitting antenna (e.g. an angle between the normal vector of the plane of the conductors and the main radiation direction of the transmitting antenna is different from 90 degrees).

### BRIEF DESCRIPTION OF THE DRAWINGS

Embodiments of the present invention will be detailed subsequently referring to the appended drawings, in which:

FIG. 1 shows a schematic illustration of an antenna device according to an embodiment of the present invention;

FIG. 2 shows a schematic illustration of neighboring, spaced apart conductors as they may be used in an embodiment of the present invention;

FIG. 3a shows a top view of spaced apart adjacent conductors as they may be found in an embodiment of the present invention;

FIG. 3b shows a top view onto an antenna device according to an embodiment of the present invention using the conductor of FIG. 3a;

FIG. 4 shows a top view onto an antenna device according to an embodiment of the present invention using the conductor of FIG. 3a;

FIG. 5a shows a block diagram of a transponder reader according to an embodiment of the present invention;

FIG. 5b shows a block diagram of an induction cooker according to an embodiment of the present invention;

FIG. 6a-c show graphics for the simulation of an electric field of an inductive antenna in lossy media; and

FIG. 7 shows a schematic illustration of a sheath shield.

### DETAILED DESCRIPTION OF THE INVENTION

Before embodiments of the present invention are described in the following in more detail with reference to the accompanying drawings, it is noted that the same or functionally like elements are provided with the same reference numerals and that a repeated description of these elements is omitted. Consequently, the description of elements having the same reference numerals is mutually interchangeable and/or may respectively be applied.

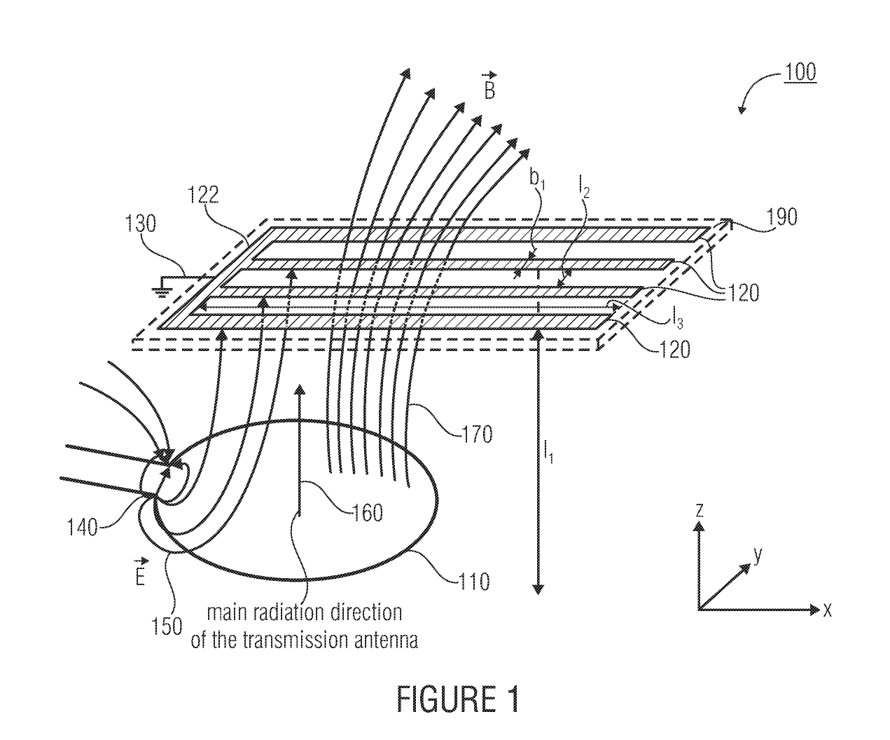

FIG. 1 shows a schematic illustration of an antenna device 100. The antenna device 100 comprises an inductive transmitting antenna 110 with a main radiation direction 160. Further, the antenna device 100 comprises a plurality of spaced apart adjacent conductors 120 and a reference potential terminal 130 connected to the conductors 120. The conductors 120 are arranged in a predetermined distance 1₁ from the transmitting antenna along the main radiation direction 160 in a plane anti-parallel to the main radiation direction 160. In other words, the conductors 120 are arranged in the main radiation direction 160 of the transmitting antenna 110.

A transmitting antenna may in the following also be referred to as a transmitting coil, wherein a transmitting antenna or a transmitting coil may comprise one or several windings.

A receiving antenna may in the following also be referred to as a receiving coil, wherein a receiving antenna or receiving coil may comprise one or several windings.

The plurality of conductors may in the following also briefly be referred to as the conductors.

The inductive transmitting antenna 110 in FIG. 1 comprises only one conductor loop, may, however, also comprise several windings according to further embodiments, for example, in the form of a coil. The inductive transmitting antenna 110 in the example of FIG. 1 is placed in the xy plane of the Cartesian coordinate system, so that the main radiation direction 160 of the transmitting antenna 110 passes perpendicular to the xy plane in the direction of the z-axis. The main radiation direction 160 of the transmitting antenna 110 is characterized by the fact that a magnetic field designated by magnetic field lines 170 of the transmitting antenna 110 propagates most strongly in this direction. When using the antenna device 100 in a transponder reader, the main radiation direction 160 of the transmitting antenna 110 is that direction in which the largest reader range results for a transponder. The spaced apart conductors 120 are located in a plane (for example in a plane parallel to the xy plane and with a distance along the z axis to the xy plane) anti-parallel to the main radiation direction 160, i.e. anti-parallel to the z-axis in order to shield or reduce a parasitic electric field of the transmitting antenna 110 designated by electric field line 150 and in doing so not to influence the magnetic field of the transmitting antenna 110 negatively (or only negligibly). The parasitic electric field of the transmitting antenna 110 for example results at a feed 140 of the transmitting antenna 110.

It may be gathered from FIG. 1 that the field lines 170 of the magnetic field of the transmitting antenna 110 pass through the conductors 120 while the field lines 150 of the parasitic electric field end at the conductors 120. The parasitic electric field originating from the feed 140 thus flows off via the conductors 120 in the reference potential terminal 130 (which is for example a ground terminal of the antenna device 100). A width b₁ of the conductors 120 and a distance 1₂ of two adjacent conductors 120 is here selected so that the parasitic electric field is sufficiently shielded, but that through the magnetic field no or only insignificantly low eddy currents are induced in the conductors 120 which would weaken a field strength of the magnetic field and thus negatively influence the magnetic field.

A parasitic electric field of the transmitting coil 110 shielded by the conductors 120 may for example comprise a field strength of a maximum of 20%, a maximum of 10%, a maximum of 5% or a maximum of 1% directly behind the conductors 120 as compared to the field strength directly in front of the conductors 120 (for example at the heating point 140). A magnetic field of the transmitting coil 110 may here, for example, be maximally weakened by the conductors 120, so that the magnetic field directly behind the conductors still comprises at least 80%, at least 90%, at least 95% or at least 99% of a field strength in front of the conductors 120 (for example directly in a coil range of the transmitting antenna 110).

As mentioned above, if the conductors 120 are arranged in a plane anti-parallel to the main radiation direction 160 of the transmitting antenna 110, then the conductors may, for example, be arranged in a plane which is parallel to the xy plane of the transmitting antenna 110. In other words, the conductors 120 may be arranged in a plane which is orthogonal to the main radiation direction 160 of the transmitting antenna 110.

According to further embodiments, the conductors 120 may also be arranged in a plane which is anti-parallel to the xy plane of the transmitting antenna 110 and anti-parallel to the main radiation direction 160 of the transmitting antenna 110. For example, the conductors 120 may be arranged so that one field line of the field lines 150 of the parasitic electric field exactly intersects one conductor of the plurality of the conductors 120.

According to further embodiments, an angle between the plane of the conductors 120 and the main radiation direction 160 of the transmitting antenna 110 may be in a range of 40°-140°, of 60°-120°, of 80°-100° or of 85°-95°.

Although in the embodiments illustrated in FIG. 1, the conductors 120 all extend in the same direction of extension (in the direction of the x-axis), in further embodiments of the present invention the conductors 120 may also extend in different directions within their plane.

In the embodiment of FIG. 1, the conductors 120 are connected to each other via a connecting bridge 122, for example made of the same electrically conductive material as the conductor 120 and are connected to the reference potential terminal 130. The connecting bridge 122 here passes in the plane of the conductors 120 perpendicular to the direction of extension of the conductors 120.

According to some embodiments, the conductors 120 may be wires or bars of an electrically conductive material, for example copper.

According to further embodiments, the conductors 120 may be conductive traces, like, for example of copper, on an electrically non-conductive substrate 190 (illustrated in dashed lines in FIG. 1). The non-conductive substrate 190 may here, for example, be a circuit board. Such a circuit board may for example be a PCB (“printed circuit board”), for example with a so-called FR4 dielectric. Such (copper) conductive traces may, in particular compared to wires or metal bars, be manufactured in a comparatively simple way in virtually any width and in particular virtually any distance to each other, however small, on the non-conductive substrate 190. Further, when using a multi-layer conductive plate as a substrate 190, the conductors 120 may be realized on a layer of the multi-layer conductive plate and the inductive transmitting antenna 110 on another layer of the same multi-layer conductive plate. The distance 1₁ between the inductive transmitting antenna 110 and the conductors 120 may thus be kept small with little effort. Thus, for example, between the transmitting antenna 110 and the conductors 120, only one insulating layer of the conductor plate may be arranged. The transmitting antenna 110 may in this case for example be realized as a conductor loop of one or several conductor traces on the conductor plate. The conductors 120 may, for example, be realized on one side or surface of a conductor plate and the transmitting antenna 110 may, for example, be realized on an opposing side or surface of the conductor plate.

According to further embodiments, the conductors 120 may also be arranged in a housing in which the transmitting antenna 110 is arranged. The conductors 120 may here be arranged so that with a proper use of the antenna device 100 the conductors 120 are arranged between a receiving antenna which receives the magnetic field radiated by the transmitting antenna 110 and the transmitting antenna 110. Such a receiving antenna may, for example, be an antenna of a transponder, for example an RFID transponder. With the use of the antenna device 100 in a hot plate of an induction cooker, the conductors 120 may, for example, be arranged between a pan or a pot and the transmitting antenna 110.

Generally, it may be noted that in order to shield the parasitic electric field of the transmitting antenna 110 as well as possible, the distance 1₂ between two neighboring conductors 120 ought to be selected as small as possible, and in order to prevent eddy current losses in the magnetic field of the transmitting antenna 110, the width b₁ of the conductors 120 ought to be selected as small as possible.

A length l₃ of the conductors 120 advantageously ought to be in a range around a given factor smaller than a useful wavelength of the antenna device 100. The factor may, for example, be greater than or equal to 10, greater than 20, greater than 50, greater than 100 or greater than 250.

A usable frequency (which directly results from the useful wavelength) of the antenna device 100 is here typically a frequency using which the transmitting antenna 110 sends out a carrier, for example to supply a passive transponder with energy. Typical usable or useful frequencies for inductive transponder systems for example are 125 kHz, 134.2 kHz, 6.78 MHz or 13.56 MHz.

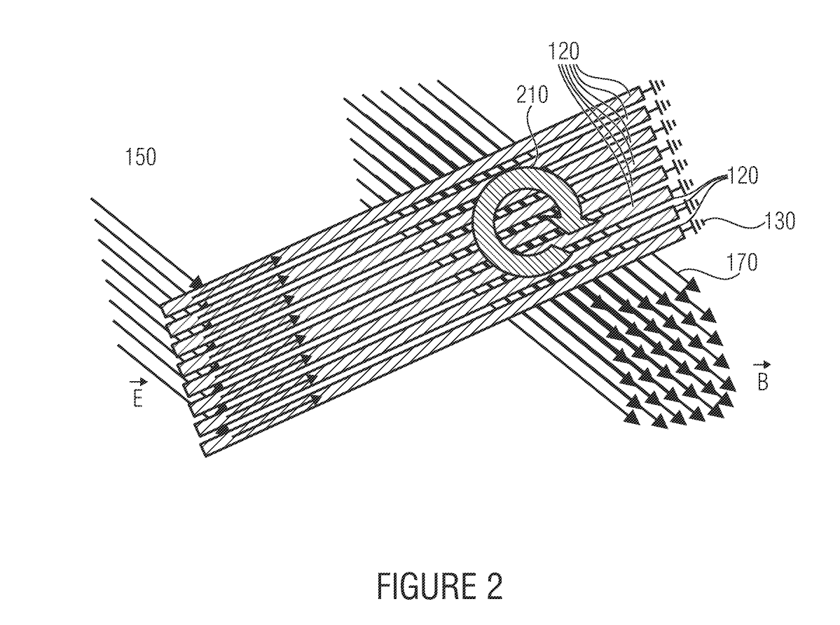

FIG. 2 shows a plurality of conductors 120 as they may be used in one embodiment of the present invention. What is not shown here is a transmitting antenna 110 in whose main radiation direction the conductors 120 are arranged in order to shield a parasitic electric field generated by the transmitting antenna 110 and to let a magnetic field pass generated by the transmitting antenna 110. Each of the conductors 120 is connected to a reference potential terminal 130. The reference potential terminal 130 may, for example, be a ground terminal. It may be gathered from FIG. 2 that a parasitic electric field (represented by field lines 150) is shielded by the conductors 120 and that a magnetic field (represented by field lines 120) is let through by the conductors 120 (not negatively influenced or only negligibly influenced by the conductors).

The conductors 120 form a conductive area like e.g. a copper laminated circuit board (as already described above) which is interrupted in stripes or bands. The resulting conductors 120 or copper traces do not allow a vortex-like current flow (or only a negligibly small vortex-like current flow). With a non-laminated circuit board (i.e. with a continuous metallic surface) the magnetic field represented by the field lines 170 would generate a vortex-like current flow perpendicular to the field lines 170 in the conductive surface (illustrated by the arrow 210) which weakens the magnetic field or reduces a field strength of the magnetic field. As already described above, by a suitable selection of the distances of the conductors 120 to each other and the width of the conductors 120 this vortex-like current flow may be reduced and simultaneously the parasitic electric field may be shielded in a sufficiently high measure.

Embodiments of the present invention thus enable a shielding of an electric field directly behind an antenna coil or a transmitting antenna 110, like an area shield, at the same time, however, no negative (or only an insignificantly low negative) influencing of the magnetic field, like a sheath shield.

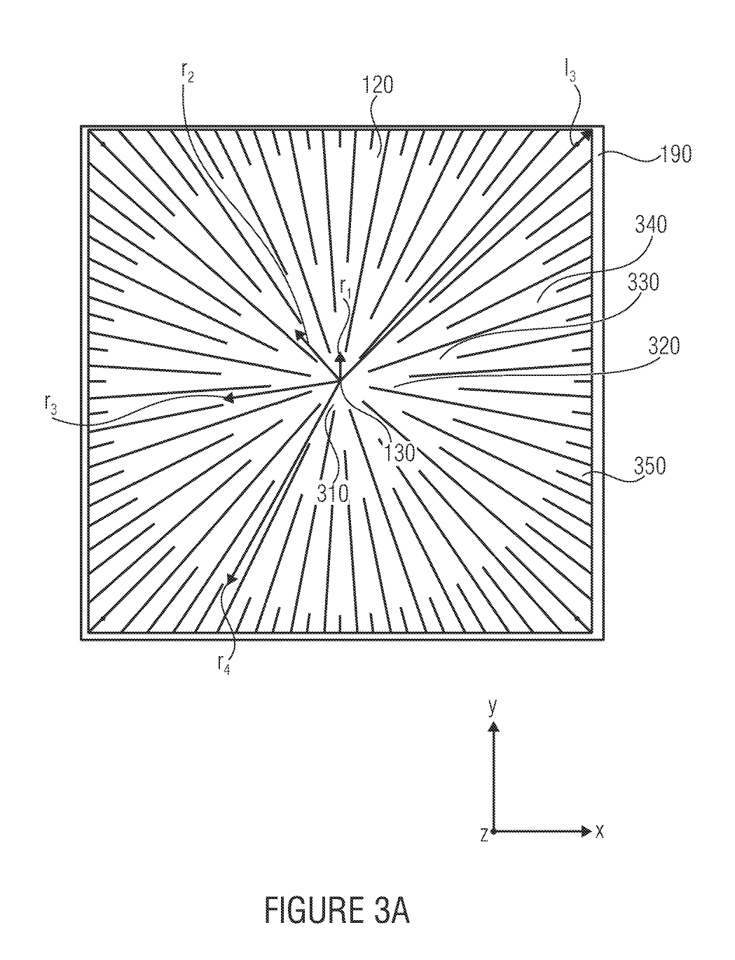

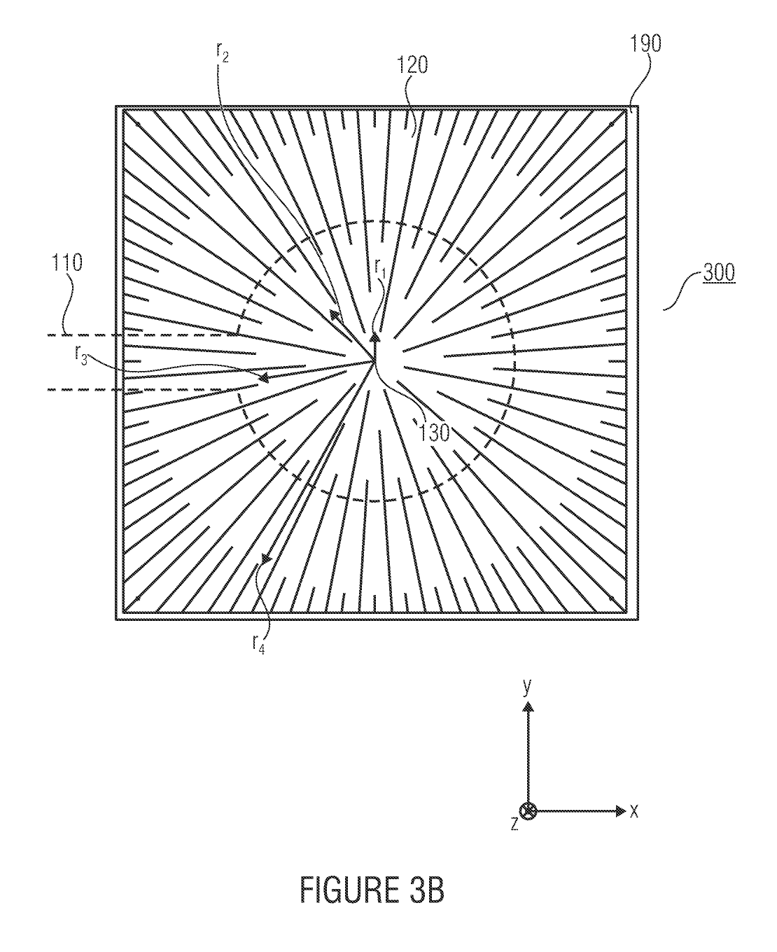

FIG. 3a shows a top view onto a plurality of spaced apart adjacent conductors 120 as they may be used in one embodiment of the present invention. The conductors 120 may, for example, be conductive traces on a circuit board 190, in other words, the conductive traces may thus form a copper laminated circuit board 190 which is interrupted in bands or stripes. The conductors 120 or the conductive traces 120 are connected to each other in a center 420 (a center point of an area 310) of the copper laminated circuit board 190 and connected to a reference potential terminal 130. The reference potential terminal 130, like in the other embodiments, serves for connecting the conductor 120 to ground, to enable a shielding of a parasitic electric field with a use of the conductor 120 in an embodiment according to the present invention. The conductors 120 or electrically conductive material of the conductors 120 are or is represented in FIG. 3a by light areas and slots between the individual conductors 120, i.e. electrically non-conductive material (for example, air gap or non-conductive substrate material) is illustrated by dark areas.

As in the above embodiments, the conductors 120 are arranged in one plane. An area 310 extends like a circle from a center 420 of the plane (for example from the center 420 of the circuit board 190 or the substrate on which the conductors 120 are arranged) with a distance r₁ to the outside with reference to the plane of the conductors 120. The conductors 120 extend from the area 310 radially outward with reference to the plane. The conductors 120 are conductively connected with each other in the area 310. In a distance r₂ from the center 420 of the circuit board 190 which is greater than the distance r₁, the conductors 120 branch a first time, so that a conductive trace density or a conductor density does not decrease to the outside (or is the same after each branch). Each of the conductors 120 here branches into two spaced apart adjacent partial conductors which are conductively connected to each other via the conductor from which they originate. These partial conductors again branch in a distance r₃ from the center 420 of the circuit board 190 which is greater than the distance r₂. Analog to the branching of the conductors in the distance r₂, each partial conductor branches in a distance r₃ into two further partial conductors which are conductively connected to the partial conductors from which they originate. In a distance r₄ to the center 420 of the circuit board 190 which is greater than the distance r₃, the partial conductors which originated from the branching in the distance r₃ again branch.

According to further embodiments, the area 310 may also extend as a square, a rectangle or a free form from the center 420.

According to further embodiments, a circuit board as a substrate may be omitted, for example, when the plurality of conductors 120 form a wire netting and are connected to each other in the center 420 and/or the area 310.

Due to the repeated branching of the conductors 120 in different distances from the center 420 from which the conductors 120 extend, it is guaranteed that a width of a conductor remains small so that in the conductor no vortex-like current flow (or only a negligible vortex-like current flow) may result.

Due to the branchings, a number of spaced apart adjacent conductors in an area 350 which extends from the distance r₄ outward to an edge of the circuit board is double as high as a number of the conductors in an area 340 which extends from the distance r₃ to the distance r₄. Further, the number of the conductors in the area 340 is double as high as a number of conductors in an area 330 which extends from the distance r₂ to the distance r₃. Further, the number of the conductors in the area 330 is double as high as a number of conductors in an area 330 which extends from the distance r₁ to the distance r₂.

Analog to FIG. 1 it is advantageous also here to select a width of the conductors 120 and a distance of the conductors 120 to each other as small as possible on the one hand to enable a high shielding of an electric field by a dense arrangement of the conductors 120 and on the other hand, to enable no negative influencing (or only a negligible influencing) of a magnetic field by a small width of the conductors 120. The branching points of the conductors 120 may, for example, be selected so that a width of one of the conductors 120 (in the areas 320-350) is smaller than 1 mm, smaller than 1.5 mm, smaller than 2 mm or smaller than 5 mm. A distance of adjacent conductors 120 may, for example, be selected so that the same (in the areas 310-350) is smaller than 0.1 mm, smaller than 0.2 mm, smaller than 0.5 mm or smaller than 1 mm. A maximum length l₃ of a conductor from the plurality of conductors 120 may here be selected analog to FIG. 1 so that this maximum length l₃ is smaller by a given factor than a usable wavelength of an antenna device in which the conductors 120 for shielding a parasitic electric field of a transmitting antenna of the antenna device are used. For a usable frequency of 6.78 MHz which corresponds to a wavelength of approximately 44.2 m, the maximum length l₃ of a conductor from the plurality of conductors 120 may, for example, be in a range from 10-20 cm or 12-17 cm or 14.5-15.5 cm or advantageously 15 cm±5%. The maximum length l₃ is here defined as the length of the longest conductor from the plurality of conductors 120 which extends from the center in which the conductors 120 are connected to the reference potential terminal 130 outward to an exterior edge of the area 350. According to further embodiments, the maximum length l₃ may also be adapted to an extent of a transmitting antenna 110 for example, so that the conductors 120 completely cover an area spanned by a conductor loop of the transmitting antenna 110.

If the maximum length l₃, as described above, is selected by a given factor smaller than the usable wavelength, it may be assumed that a potential along the maximum length l₃ of the conductors 120 is constant, whereby parasitic effects in the conductors 120 may be prevented.

Although in the above embodiment of conductors 120, the conductors all in all split four times (in the distances r₁, r₂, r₃ and r₄), according to further embodiments the conductors 120 may branch any number of times in order to achieve an optimum shielding of a parasitic electric field and a smallest possible or even no negative influencing of a magnetic field.

As illustrated in FIG. 3a, the distances r₁, r₂, r₃ and r₄ are radii which extend from the center of the circuit board radially outward with respect to the circuit board in the plane.

As it may be gathered from FIG. 3a, a distance between two neighboring conductors may be the same for all conductors from the plurality of conductors 120. Further, a distance between two neighboring partial conductors which originated from a branching of a conductor of the plurality of conductors 120 may be the same for all partial conductors and in particular be exactly as large as a distance between two adjacent conductors from the plurality of conductors 120.

Further, for example, a distance between two neighboring conductors from the plurality of conductors 120 may substantially be constant along extension directions (from the center outward, for example along the distances r₁, r₂, r₃ and f₄) of the two neighboring conductors from the distance r₁ outward with reference to the plane or may vary along the extension directions by a factor smaller 5%, smaller 10%, smaller 25% or smaller 50%.

Basically, this application discloses that a tolerance range of ±2% is acceptable.

Analog to that, for example, also a distance of two adjacent partial conductors (which result from a branching of a conductor from the plurality of conductors 120) may be substantially constant along the directions of extension of the two neighboring partial conductors outward with respect to the plane or vary along the directions of extension by a factor smaller than 2%, smaller 5%, smaller 10%, smaller 25% or smaller 50%. Further, the distance of two neighboring partial conductors may be equal to the distance of two neighboring conductors from the plurality of conductors 120, which extend from the distance r₁ to the distance r₂, or deviate by a factor smaller 5%, smaller 10%, smaller 25% or smaller 50% from the same.

When keeping the distances between two adjacent conductors from the plurality of the conductors 120 constant, when the plurality of the conductors 120 extends radially outward (as is the case in FIG. 3a), a width of at least one of the conductors (or both neighboring conductors) may increase with an increased distance to the center from which both neighboring conductors extend. As already mentioned, in the example illustrated in FIG. 3a, a width of the plurality of the conductors 120 is kept small by the same branching in regular distances, so that no significantly large area for inducing vortex-like current flows is formed within the width of a conductor from the plurality of conductors 120.

The distance r₂ may, for example, be selected so that a width of a conductor from the plurality of conductors 120, which splits in the distance r₂ in two spaced apart neighboring partial conductors, in the distance r₂ is maximally 1.5 times, maximally 2 times, maximally 3 times or maximally 5 times as large as a width of the conductor in the distance r₁. This rule may also apply for the branching of the partial conductors in the distances r₂, r₃ and r₄.

FIG. 3b shows a top view onto an antenna device 300 according to a further embodiment of the present invention. The antenna device 300 comprises an inductive transmitting antenna 110 and the arrangement of the plurality of conductors 120 described in FIG. 3a. The inductive transmitting or transmission antenna 110 is illustrated in dashed lines in FIG. 3b, as it is arranged behind the conductors 120 in a z-direction which passes into the drawing plane. As described above, the conductors 120 may be arranged on a circuit board, for example in the form of a copper laminated circuit board having spaced apart conductor traces or conductive trace. The transmitting antenna 110 may be arranged behind this circuit board or be arranged as a conductor trace or several conductor traces on a further layer of the circuit board (in the z-axis direction behind or below the conductors 120).

A transponder or another device to be supplied with the magnetic field of the transmitting antenna 110 is placed before the conductors 120 with a proper use of the antenna device 300, so that the conductors 120 are arranged between the transmitting antenna 110 and the device in order to shield a parasitic electric field of the transmitting antenna 110, but to let through a magnetic field of the transmitting antenna 110.

Embodiments thus enable, in particular with implanted transponders, to reduce an electric field strength occurring directly at the human body surface due to a high needed transmitting coil voltage (in the inductive transmitting antenna 110) by a shielding acting thereupon (the conductors 120) to possibly given threshold values, without substantially weakening the magnetic field component substantial for the energy and data transmission.

This may be done by a suitably structured metal area or foil, wherein the structuring is selected so regarding its geometry that, in particular, substantially no energy distorting eddy currents (vortex-like current flows) are generated.

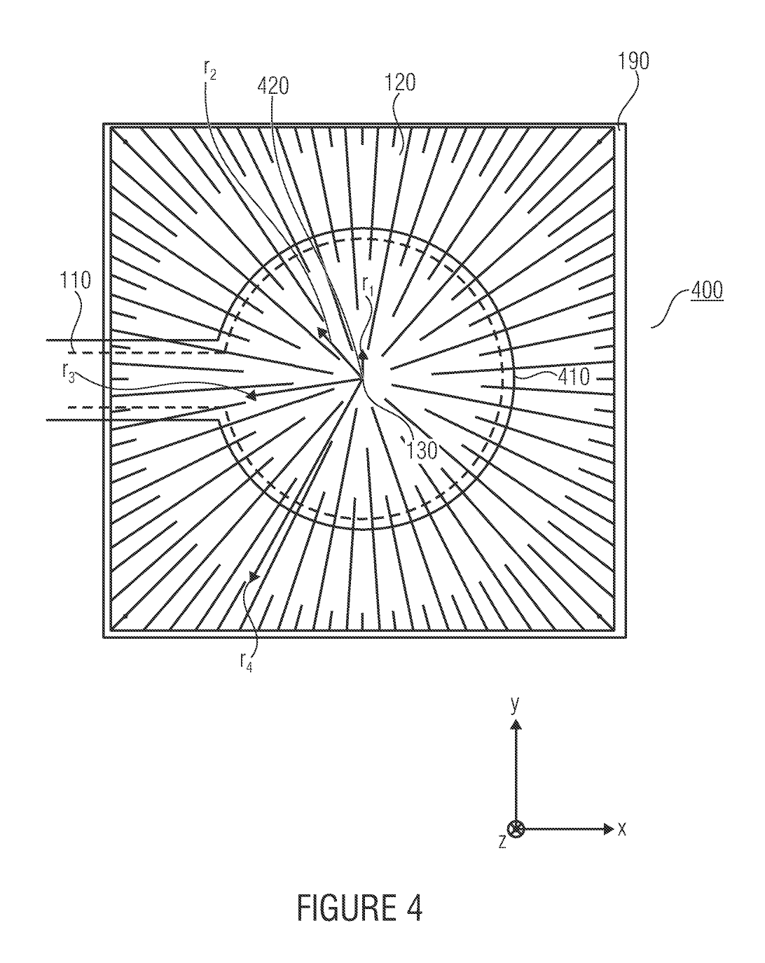

FIG. 4 shows an antenna device 400 according to one embodiment of the present invention. The antenna device 400 is different from the antenna device 300 illustrated in FIG. 3b as it further comprises a receiving antenna 410 having a main sensitivity direction. The receiving antenna 410 is arranged so that its main sensitivity direction is opposed to the main radiation direction of the transmitting antenna 110. In particular, the receiving antenna 410 may be arranged in the main radiation direction of the transmitting antenna 110. While the transmitting antenna 110, looking into the drawing plane, is arranged behind the conductors 120, the receiving antenna 410 is arranged in front of the conductors 120. Thus, in addition to reducing the electric field strength in an area of lossy media, like for example in an area of a human body, also an electric decoupling of a spatially neighboring transmitting antenna 110 or transmitting coil to a receiving antenna or receiving coil may be possible which is accompanied by a clear improvement of the receive situation of weak data signals despite the previously sent out high transmission field strength. A parasitic electric field generated by a high transmitting coil voltage at the transmitting antenna 110 thus has no influence (or only an insignificantly low influence) on the receiving antenna 410. This may lead to an improved signal to noise performance of the antenna device 400 compared to antenna devices in which no shielding in the form of spaced apart conductors 120 exists, which leads to a higher sensitivity of the antenna device 400 and thus to a higher reader range.

As illustrated in FIG. 4, according to some embodiments, the transmitting antenna 110, the conductors 120 and the receiving antenna 410 may be arranged in different planes which are parallel to each other and spaced apart from each other. The transmitting antenna 110, the conductors 120 and the receiving antenna 410 or its coil areas may here at least partially or completely overlap. A person skilled in the art knows that to enable an optimum shielding of the parasitic electric field of the transmitting antenna 110, the conductors 120 advantageously overlap a complete coil area of the transmitting antenna 110 and a feed-in of the transmitting antenna 110 (which may of course also apply for the other embodiments described in this application).

As already described above, both the conductors 120 may be arranged on a circuit board and also the transmitting antenna 110. Further, also the receive antenna 410 may be arranged on the same circuit board, for example in another layer than the conductors 120 and the transmitting antenna 110. Thus, for example, the transmitting antenna 110 may be arranged on a so-called bottom layer, the conductors 120 on an intermediate layer and the receiving antenna 410 on a so-called top layer of a circuit board. According to further embodiments, the transmitting antenna 110 and the receiving antenna 410 may also be implemented as separate coils, wherein the conductors 120, for example in the form of a foil, are arranged between the transmitting antenna 110 and the receiving antenna 410.

Although in the embodiment illustrated in FIG. 4, the conductors 120 are arranged in a plane between the transmitting coil 110 and the receiving coil 410, the transmitting coil 110 and the receiving coil 410 may also be arranged in a common plane and the conductors 120 may be arranged in a plane above or below this common plane. Also with an arrangement of the transmitting coil 110 and the receiving coil 410 in the common plane, the coil areas of the transmitting coil 110 and the receiving coil 410 may overlap, thus, for example, in one embodiment of the present invention, the transmitting coil 110 may extend around the receiving coil 410.

Although in the embodiment illustrated in FIG. 4 a radial arrangement of the conductors 120 between the transmitting antenna 110 and the receiving antenna 410 was used, according to further embodiments also any other arrangement of the spaced apart neighboring conductors 120 may be used, for example, a parallel arrangement, as it was illustrated in FIG. 1.

The use of a radial arrangement of the neighboring, spaced apart conductors 120, as illustrated in FIG. 4, enables a completely symmetrical arrangement of the conductors with respect to a circular conductor loop of the transmitting antenna 110, as it is illustrated in FIG. 4. The symmetrical arrangement of the conductors 120 with respect to the transmitting antenna 110 leads to a detuning of the transmitting antenna 110 being kept low due to the conductors 110 arranged above the same.

Despite the symmetrical arrangement of the conductors 120 with respect to the transmitting antenna 110, the conductors 120 have influence on a resonance frequency and quality of the transmitting antenna 110, and the transmitting antenna 110 may thus, according to further embodiments, be adapted to the conductors 120 with respect to its resonance frequency, so that the resonance frequency of the transmitting antenna 110, despite the arrangement of the conductors 120 in a small distance to the same, is in the desired range, like for example 6.78 MHz.

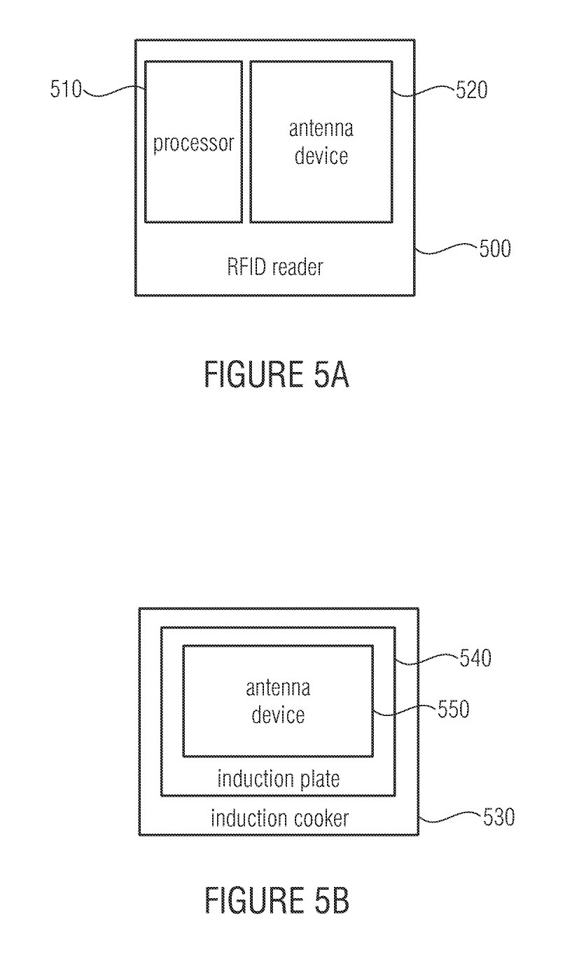

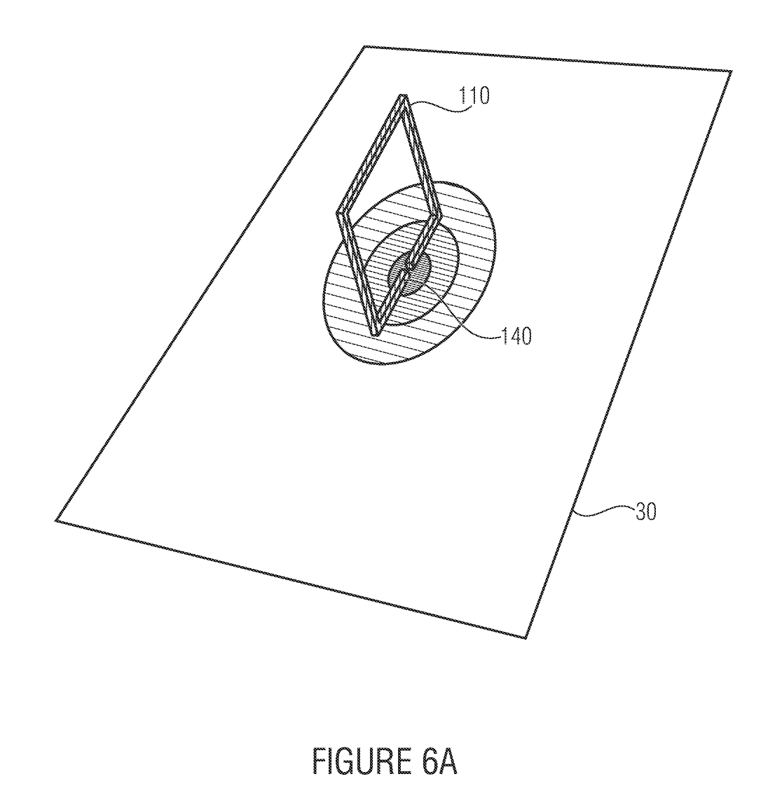

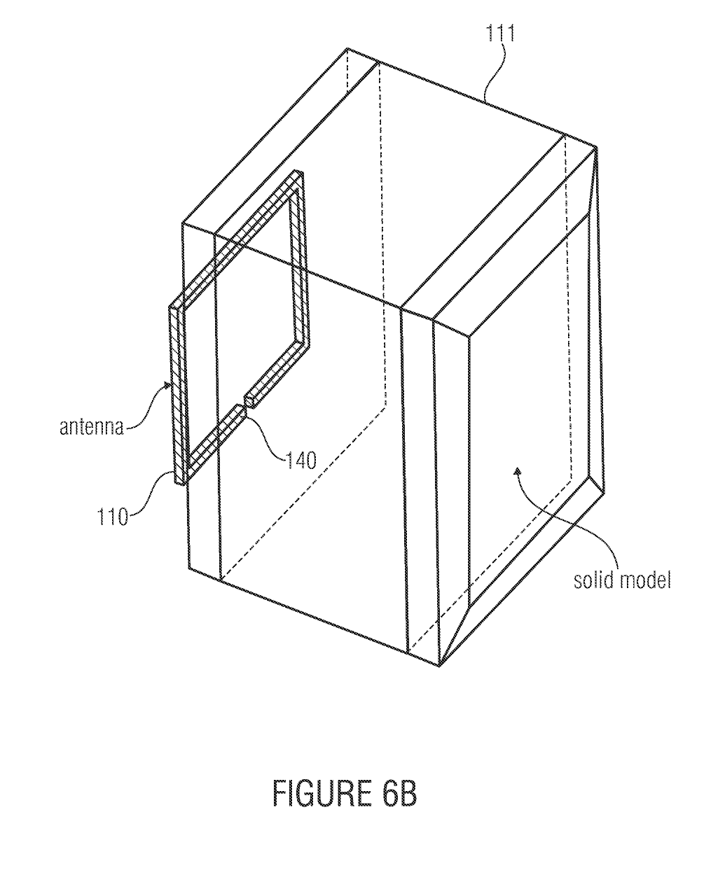

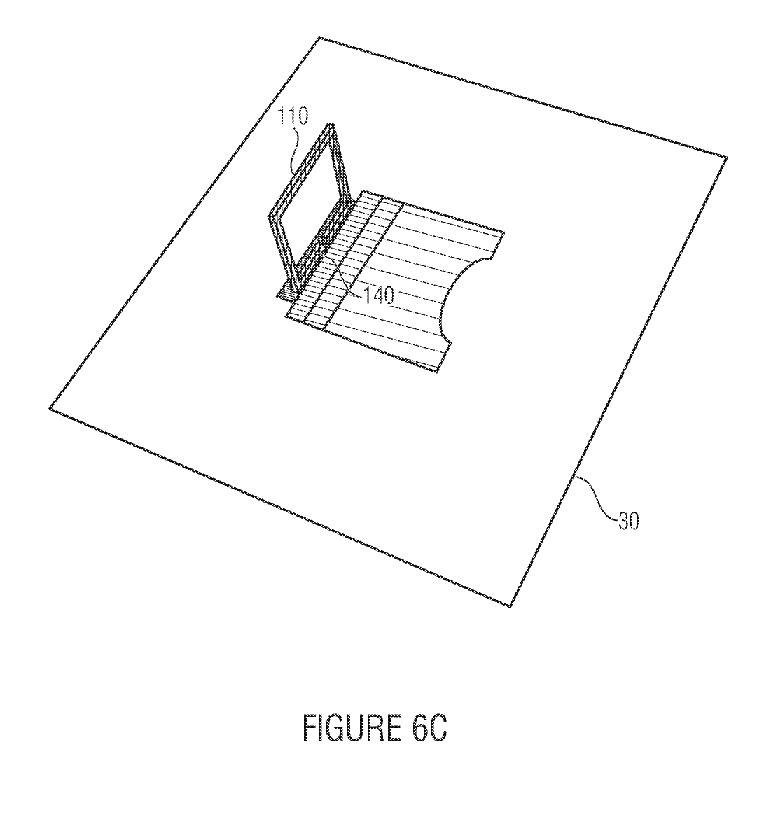

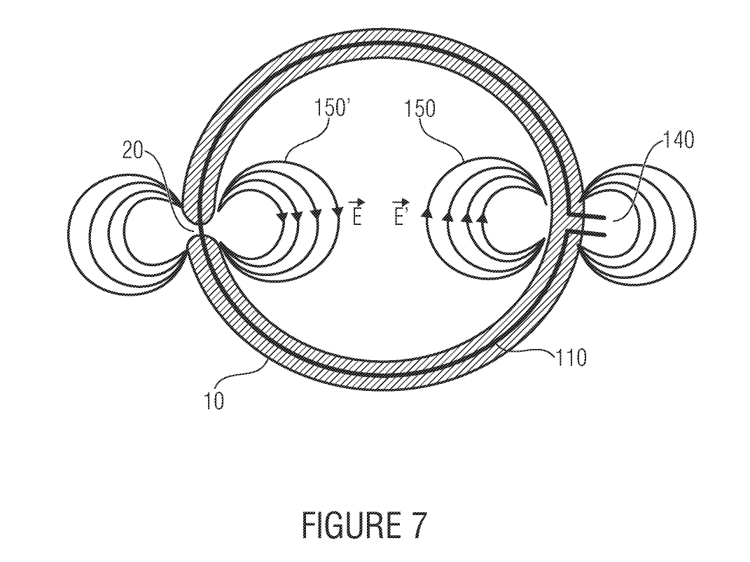

FIG. 5a shows a block diagram of a transponder reader 500. The transponder reader 500 may also be referred to as a reader. The transponder reader 500 comprises a processor 510 and an antenna device 520. The antenna device 520 may, for example, be one of the antenna devices illustrated in one of the preceding embodiments, for example the antenna device 100 of FIG. 1 or the antenna device 300 of FIG. 3b or the antenna device 400 of FIG. 4. The transponder reader 500, due to the use of the antenna device 520 (which comprises conductors 120 to suppress a parasitic electric field of a transmitting antenna 110 of the antenna device 520) may comprise an increased range with respect to known transponder readers in which a parasitic electric field of a transmitting coil of the transponder reader is not shielded. Further, the power consumption of the transponder reader 500 may be lower with the same reading range than it is possible with transponder readers without a shielding of the electric field, as in the transponder reader 500 illustrated in FIG. 5a no (or only an insignificantly low) energy is converted into heat due to the parasitic electric field in a lossy medium. In particular in medical application this is an advantage as an unnecessary heating of human tissue is to be prevented. Further, a transmitting coil voltage may be selected higher and thus a field strength of the transmitting magnetic field may be selected higher with the transponder reader 500 than with transponder readers without a shielding of the parasitic electric field and still the same threshold values with respect to an electric field strength may be maintained. The transponder reader 500 may, for example, be an RFID reader, NFC (“Near Field Communication) reader or another wireless communication device which uses a magnetic field for transmitting data.

FIG. 5b shows a block diagram of an induction cooker 530 according to an embodiment of the present invention. The induction cooker 530 comprises an induction plate 540. The induction plate 540 comprises an antenna device 550. The antenna device 550 may, for example, be one of the above described antenna devices, for example the antenna device 100 according to FIG. 1 or the antenna device 300 according to FIG. 3b. A use of the antenna device 550 according to one embodiment of the present invention in the induction cooker 530 enables a shielding of a parasitic electric field of a transmitting antenna 110 of the antenna device 550 of the induction cooker 530 which is used for the induction of an eddy current in a pot or a pan (or other induction cooking tableware) by a magnetic field of the transmitting antenna 110. As no unnecessary energy results in a heating of lossy media by a parasitic electric field of the transmitting antenna 110 of the antenna device 550, an energy consumption of the induction cooker 530 may be kept lower with the same magnetic field strength than an energy consumption of an induction cooker which comprises an antenna arrangement without a shielding of an electric field of a transmitting antenna of the antenna arrangement.

In summary, it may be noted that a substantial advantage of embodiments of the present invention is the capability to absorb parasitic electric fields of an inductive antenna in the direct vicinity without negatively influencing the magnetic field. By this, for example, the use of transponder systems is possible in which an antenna of the reader is in contact with lossy material (like for example human tissue).

Embodiments may be used in all inductive transmission systems. And with a particular advantage, embodiments may be used in all inductive transmission systems in which a field generating antenna is used in the direct vicinity of lossy materials.

Embodiments of the present invention thus provide a shield for an inductive antenna which is implemented to absorb parasitic electric fields of the inductive antenna in the direct vicinity without negatively influencing the magnetic field.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An antenna device, comprising:
an inductive transmitting antenna comprising a main radiation direction;
a plurality of spaced apart adjacent conductors; and
a reference potential terminal connected to the plurality of conductors;
wherein the plurality of the conductors is arranged in a predetermined distance from the inductive transmitting antenna along the main radiation direction in one plane;
wherein an angle exists between the plane of the conductors and the main radiation direction;
wherein the plurality of the conductors extend radially outwards originating from a first area within the plane, wherein the plurality of conductors in the first area are conductively connected to each other and to the reference potential terminal, and
wherein each of the conductors branches into two adjacent partial conductors at a position spaced apart from the first area.

2. The antenna device according to claim 1, wherein the plurality of the conductors extend in parallel to each other in a common extension direction in the plane.

3. The antenna device according to claim 1, wherein a width of conductors of the plurality of conductors is identical or deviates by a maximum of 10%.

4. The antenna device according to claim 1, wherein a distance between two adjacent conductors from the plurality of conductors along extension directions of the two adjacent conductors is basically constant.

5. The antenna device according to claim 1, wherein a distance of two adjacent partial conductors to each other along the extension directions of the two adjacent partial conductors is basically constant.

6. The antenna device according to claim 5, wherein the distance of the two adjacent partial conductors is equal to a distance of two adjacent conductors from the plurality of conductors.

7. The antenna device according to claim 1, wherein the position where the conductors branch is selected so that a width of a conductor from the plurality of conductors which branches at this position into two spaced apart adjacent partial conductors is, at this position, maximally double as large as a width of the conductor at an edge of the first area from which the conductor extends.

8. The antenna device according to claim 1, wherein the plurality of the conductors is arranged on a first surface of a substrate of a electrically non-conductive material.

9. The antenna device according to claim 8, wherein the inductive transmitting antenna is arranged on a second surface of the substrate opposed to the first surface.

10. The antenna device according to claim 1, wherein the plurality of the conductors is arranged on a first layer of a multilayer substrate of an electrically non-conductive material.

11. The antenna device according to claim 10, wherein the inductive transmitting antenna is arranged on a second layer of the multilayer substrate which is arranged above or below the first layer of the multilayer substrate.

12. The antenna device according to claim 11, further comprising a receiving antenna arranged in the main radiation direction of the inductive transmitting antenna on a third layer of the multilayer substrate, wherein the first layer of the multilayer substrate is arranged between the third layer of the multilayer substrate and the second layer of the multilayer substrate.

13. The antenna device according to claim 1, wherein the plane in which the plurality of the conductors are arranged is orthogonal to the main radiation direction of the transmitting antenna.

14. The antenna device according to claim 1, wherein a length of a longest conductor of the plurality of the conductors is smaller by at least a factor of 100 than a useful wavelength of the inductive transmitting antenna.

15. An antenna device, comprising:
an inductive transmitting antenna comprising a main radiation direction;
a plurality of spaced apart adjacent conductors; and
a reference potential terminal connected to the plurality of the conductors;
wherein the plurality of the conductors is arranged in a predetermined distance from the inductive transmitting antenna along the main radiation direction in one plane;
wherein an angle exists between the plane of the conductors and the main radiation direction;
wherein the plurality of the conductors extend radially outwards originating from a first area within the plane, wherein the plurality of conductors in the first area are conductively connected to each other and to the reference potential terminal, and
wherein a distance between two adjacent conductors of the plurality of the conductors is constant along extension directions of the two adjacent conductors.

16. A transponder reader comprising an antenna device, comprising:
an inductive transmitting antenna comprising a main radiation direction;
a plurality of spaced apart adjacent conductors; and
a reference potential terminal connected to the plurality of conductors;
wherein the plurality of the conductors is arranged in a predetermined distance from the inductive transmitting antenna along the main radiation direction in one plane;
wherein an angle exists between the plane of the conductors and the main radiation direction;
wherein the plurality of the conductors extend radially outwards originating from a first area within the plane, wherein the plurality of conductors in the first area are conductively connected to each other and to the reference potential terminal, and
wherein each of the conductors branches into two adjacent partial conductors at a position spaced apart from the first area.

17. A transponder reader comprising an antenna device, comprising:
an inductive transmitting antenna comprising a main radiation direction;
a plurality of spaced apart adjacent conductors; and
a reference potential terminal connected to the plurality of the conductors;
wherein the plurality of the conductors is arranged in a predetermined distance from the inductive transmitting antenna along the main radiation direction in one plane;
wherein an angle exists between the plane of the conductors and the main radiation direction;
wherein the plurality of the conductors extend radially outwards originating from a first area within the plane, wherein the plurality of conductors in the first area are conductively connected to each other and to the reference potential terminal, and
wherein a distance between two adjacent conductors of the plurality of the conductors is constant along extension directions of the two adjacent conductors.

18. An induction cooker comprising an antenna device, comprising:
an inductive transmitting antenna comprising a main radiation direction;
a plurality of spaced apart adjacent conductors; and
a reference potential terminal connected to the plurality of conductors;
wherein the plurality of the conductors is arranged in a predetermined distance from the inductive transmitting antenna along the main radiation direction in one plane;
wherein an angle exists between the plane of the conductors and the main radiation direction;
wherein the plurality of the conductors extend radially outwards originating from a first area within the plane, wherein the plurality of conductors in the first area are conductively connected to each other and to the reference potential terminal, and
wherein each of the conductors branches into two adjacent partial conductors at a position spaced apart from the first area.

19. An induction cooker comprising an antenna device, comprising:
an inductive transmitting antenna comprising a main radiation direction;
a plurality of spaced apart adjacent conductors; and
a reference potential terminal connected to the plurality of the conductors;
wherein the plurality of the conductors is arranged in a predetermined distance from the inductive transmitting antenna along the main radiation direction in one plane;
wherein an angle exists between the plane of the conductors and the main radiation direction;
wherein the plurality of the conductors extend radially outwards originating from a first area within the plane, wherein the plurality of conductors in the first area are conductively connected to each other and to the reference potential terminal, and
wherein a distance between two adjacent conductors of the plurality of the conductors is constant along extension directions of the two adjacent conductors.
